(19) United States
(12) Patent Application Publication
(10) Pub. No.: US 2008/0113088 A1
(43) Pub. Date: May 15, 2008

(54) Water Adhesive, Preparation Method Thereof and Application in Manufacture of Positive Plate of Lithium Ion Battery

(75) Inventors: Yunqing Lin, Guangdong Province (CN); Zewei Chen, Guangdong Province (CN); Can Ren, Guangdong Province (CN); Xu Gao, Guangdong Province (CN)

Correspondence Address: JACOBSON HOLMAN PLLC, 400 SEVENTH STREET N.W., SUITE 600, WASHINGTON, DC, 20004, US

(73) Assignee: SHENZHEN BAK BATTERY CO., LTD., SHENZHEN, GUANGDONG PROVINCE (CN)

(21) Appl. No.: 11/883,371

(22) PCT Filed: Jan. 31, 2005
(86) PCT No.: PCT/CN05/00130

§ 371 Date: Jul. 31, 2007

(51) Int. Cl. C08L 31/00; B05D 5/12

(52) U.S. Cl. 427/77; 524/557; 524/556

(57) ABSTRACT

A water adhesive, being a hybrid solution containing gelatin, a water-soluble polymer and water, or comprising gelatin, a water-soluble polymer and water, is disclosed. The preparation method of the water adhesive and application of the water adhesive in manufacture of a positive plate of a lithium ion battery are also disclosed. The present invention has the following beneficial technical effects: The water adhesive with the above formulation can achieve a good coating effect; each ingredient is easily available, with a lower cost; the water adhesive can be prepared through simple steps, making the manufacture easy to implement, with broad prospects for industrial application.

### FIELD OF THE INVENTION

The present invention relates to the materials chemistry field and the high-energy battery technology, and particularly to a water adhesive, a preparation method thereof and application in manufacture of a positive plate of a lithium ion battery.

### BACKGROUND OF THE INVENTION

A lithium ion battery is a high-performance secondary battery. It has such advantages as high working voltage, high volume and weight energy density, long service life, low self-discharge rate, no memory effect, and environment friendliness, and is widely applied in the fields of mobile communication devices, notebook computers, video recorders, personal digital assistants (PDAs), digital cameras, electric tools, torpedoes, missiles, etc. In recent years, the manufacturing technology of the lithium ion battery has progressed considerably, such that the capacity of a cylindrical battery, Model 18650, for example, is increased from the original 1200 mAh to the present 2400 mAh. However, as for the manufacturing method of battery plates (positive plate and negative plate), the coating process is still used. The coating method is classified into oil-phase coating process and water-phase coating process. In the oil-phase coating process, positive and negative electrode active powders and a conductive agent are made into slurry with an organic solvent and an adhesive soluble in the organic solvent. In the water-phase coating process, positive and negative electrode active powders and a conductive agent are made into slurry with water as the solvent and an adhesive soluble in water. The water-phase coating technology has been adopted in the current mass production of negative plates, for example, with water as the solvent and sodium carboxymethylcellulose (CMC) and styrene butadiene rubber (SBR) latex as the adhesive. However, the oil-phase coating technology is generally used in the mass production of positive plates. The adhesive most used currently is a fluoropolymer adhesive, for example, using polyvinylidene fluoride (PVDF) and N-methylpyrrolidone solutions as the adhesive. With a fluoroolefin polymer as the adhesive of the positive electrode material of the lithium ion battery, the vaporized solvent produced in the manufacturing process will not only pollute environment, but also endanger operators' health. Moreover, the fluoropolymer solvent is expensive, which will undoubtedly increase the production cost of lithium ion battery.

In order to resolve the problems, R&D work has also been done on the water adhesive of the positive electrode material of the lithium ion battery. R. Dominko et al. proposed a manufacturing method of the positive plate using a water adhesive (R. Dominko et al., Electrochemical and Solid-state Letters, 4(11) A187-A190 (2001)), which is as below: First, treat the particles of positive electrode material to be applied with a polyelectrolyte such as gelatin; then add a highly conductive carbon black (Printen XE2, Degussa), so that each particle of the positive electrode material is deposited on the surface with a layer of carbon black particles of 0.1 μm in particle size; and finally make the particles of positive electrode material treated with gelatin and carbon black adhere to a current-collecting aluminum foil with an additional polyelectrolyte (gelatin, cellulose, etc.) to get an electrode plate. However, the following disadvantages exist in the manufacturing process of positive plates with the common mass production equipments according to the method proposed by R. Dominko et al.: (1) Adhesion between the positive electrode material and the aluminum foil is poor, which results in serious falling of materials, especially in a single-side coating process. (2) The aluminum foil adhered with the positive electrode slurry turns out to be hard with gelatin as the adhesive, and less flexible than that with polyvinylidene fluoride (PVDF) as the adhesive. (3) Due to too low the molecular weight of gelatin, the positive plate with a qualified surface density cannot be obtained merely with gelatin as the adhesive, that is, the positive plate with a sufficient thickness cannot be obtained. A water adhesive was disclosed in the Chinese patent CN 01108511 and CN 01108524, whose preparation method is as below: With a hydrophilic monomer and a lipophilic monomer denoted by the general formula of CH₂═CR₁R₂ as the starting monomer, mix one, two or more kinds of hydrophilic monomers and one, two or more kinds of lipophilic monomers, and add an emulsifier and other assistants; with a redox system as the initiating system composed of a water-soluble initiator such as ammonium persulfate, Na₂SO₃, FeSO₄, etc., react at 30-80° C. for 3-24 hours to produce the water adhesive. This preparation method, with a relatively higher production cost and a more tedious preparation process, has no use value to industrial production.

### SUMMARY OF THE INVENTION

The purpose of the present invention is to provide a water adhesive with good coating effect, lower cost, and easy availability, the preparation method thereof, and the application in manufacture of the positive plate of the lithium ion battery.

The technical solution of the present invention is as below so as to resolve the above problems: A water adhesive, being a solution containing gelatin, a water-soluble polymer and water; and

a water adhesive, comprising gelatin, a water-soluble polymer and water.

The content of gelatin is preferably 1%-5% by weight, the water-soluble polymer 0.1%˜2%, with the remaining being water.

The content of gelatin is more preferably 1.5%-4% by weight.

The content of water-soluble polymer is more preferably 0.5%-1.5% by weight.

The water-soluble polymer can be selected from the following high molecular compounds or their mixtures: Polyvinyl alcohol (PVA), polyethylene oxide (PEO), polyacrylamide, sodium polyacrylate, polyacrylate, and polyvinylpyrrolidone. The molecular weight of polyvinyl alcohol (PVA) is 5,000-200,000, polyethylene oxide (PEO) 10,000-500,000, sodium polyacrylate 50,000-300,000, polyacrylamide 10,000-500,000, polyacrylate 50,000-200,000, and polyvinylpyrrolidone 50,000-300,000.

The water-soluble polymer is preferably polyvinyl alcohol (PVA), polyethylene oxide (PEO), sodium polyacrylate, polyacrylate or their mixtures. The molecular weight of polyvinyl alcohol (PVA) is preferably 50,000-450,000, polyethylene oxide (PEO) 50,000-450,000, sodium polyacrylate 50,000-250,000, and polyacrylate 50,000-150,000.

Most preferably, the water-soluble polymer is polyethylene oxide with a content of 1.3% by weight, and the content of gelatin is 2% by weight.

The water adhesive of the present invention can be prepared through a process includes the following steps:

(a) Dissolve the scaled gelatin in water.

(b) Titrate the above solution with an alkaline solution to make its pH value being 7-9.

(c) Then add the scaled water-soluble polymer to the solution.

(d) Stir the solution to completely dissolve the ingredients.

Gelatin can be dissolved in water thereinto in Step (a) through the following method: Add gelatin in water, heat up to 50° C.-80° C., and stir to make gelatin completely dissolved. In Step (c), add the water-soluble polymer after the solution cools down to the room temperature.

The alkaline solution is preferably LiOH solution.

The water adhesive of the present invention can be applied in the manufacturing process of the positive plate of the lithium ion battery.

The present invention also provides the positive plate manufactured with the water adhesive of the present invention, and the lithium ion battery provided with the positive plate.

By adopting the above technical solution, the beneficial technical effects of the present invention are as follows based on the following embodiments to be illustrated in details below: 1) The water adhesive with the above formulation can achieve a good coating effect. 2) Each ingredient of the present invention is easily available, with a lower cost. 3) The water adhesive can be prepared through simple steps, making the manufacture easy to implement, with broad prospects for industrial application.

The present invention will be further described in details through embodiments and with reference to appended drawings. An electrode plate is manufactured with the water adhesive of the present invention according to the prior art. With it a steel-clad battery 053048S is further manufactured. The application effect of the present invention is explained through test and investigation of the electrochemical and charge-discharge performance of the battery.

### BRIEF DESCRIPTION OF THE DRAWINGS

FIG. 1 is a 100-cycle performance graph of the lithium ion battery provided with the positive plate manufactured with the adhesive of the present invention.

FIG. 2 is a tendency graph of discharge capacity attenuation of the lithium ion battery provided with the positive plate manufactured with the adhesive of the present invention.

FIG. 3 is a comparative graph of discharge capacity between the lithium ion battery provided with the positive plate manufactured with the adhesive of the present invention and a lithium ion battery provided with a positive plate manufactured with an adhesive with PVDF as the solvent.

### DETAILED DESCRIPTION OF THE EMBODIMENTS

The present invention provides a water adhesive containing gelatin, a water-soluble polymer and water, which can be applied in manufacture of a positive plate of a lithium ion battery. In this application, gelatin can make the conductive carbon black uniformly adhere to the surface of the positive electrode active material, thus increasing conductivity of the positive electrode active material. If the content of gelatin is too low (<1%), the conductivity of positive electrode active material may not be effectively improved; and if the content is too high (>5%), the coated positive plate may be excessively high in hardness, and the aliquation phenomenon is likely to occur. The water-soluble polymer can increase viscosity of the adhesive, increase the adhesion between the positive electrode slurry and the current collector, and improve coating performance of the positive electrode slurry. If the content of the water-soluble polymer is too low (<0.1%), the adhesive viscosity is insufficient, which may result in poor retention of the positive electrode slurry on the current collector, and difficulty in controlling surface density of the positive plate; and if the content is too high (>2%), the adhesive viscosity may be too high, which is also to the disadvantage of application of the positive electrode slurry, and will result in a high internal resistance of the battery provided with the positive plate. Besides, as for the selection of water-soluble polymers, it is feasible to use a water-soluble polymer having a high molecular weight and that having a low molecular weight together, and control the average molecular weight around 200,000-300,000, so as to achieve better effects. Water is used to dissolve gelatin and the water-soluble polymers. If the water is far from sufficient, gelatin and the water-soluble polymers cannot be completely dissolved; and if the water is too much, the slurry made with the adhesive will be too thin, which is unfavorable for the coating process.

The adhesive can be prepared by the following method:

(a) Dissolve the scaled gelatin in water.

(b) Titrate the above solution with an alkaline solution to make its pH value being 7-9.

(c) Then add the scaled water-soluble polymer to the solution.

(d) Stir the solution to completely dissolve the ingredients.

The reason for adjusting the pH value to 7-9 during preparation of the adhesive is as below: Gelatin is mainly composed of amino acid molecules, which are an amphoteric compound and between which strong hydrogen bonds can be formed under this environment, which will enhance the adhesion, make the conductive agent adhere to the surface of the positive electrode active material more uniformly during the slurry preparation process, and enhance the conductivity. An excessive high (>9) or an excessive low (<7) pH value will be to the disadvantage of formation of the hydrogen bonds, which will further result in poor conductivity of the prepared slurry. The alkaline solution for adjusting the pH value is preferably LiOH, with which no impurities will not introduced into the solution, and thus the electrochemical performance of the battery will not be affected.

Hereinafter, the implementation and effects of the present invention are illustrated in details with reference to the specific embodiments.

### Embodiment 1

Add 568 ml water in a 1000 ml beaker, put the beaker on a magnetic stirrer, and heat up to 50° C.; then add 11.6 g gelatin, stir to make it completely dissolved, and titrate with 0.1 M LiOH to adjust pH value of the solution to 8; add 2.9 g PEO with a molecular weight of 450,000 after the solution cools down to the room temperature, continue to stir to make the PEO completely dissolved, and finally obtain a light-yellow translucent viscous liquid.

### Embodiment 2

The adhesive preparation method and the proportion of each ingredient of this embodiment are basically the same with those of Embodiment 1, with the only difference being PVA as the water-soluble polymer of the embodiment with a molecular weight of 450,000; and the final product is a light-yellow translucent viscous liquid.

### Embodiment 3

Add 576 ml water in a 1000 ml beaker, put the beaker on a magnetic stirrer, and heat up to 50° C.; then add 18 g gelatin, stir to make it completely dissolved, and titrate with 0.1 M LiOH to adjust pH value of the solution to 7; add 6 g sodium polyacrylate with a molecular weight of 250,000 after the solution cools down to the room temperature, continue to stir to make sodium polyacrylate completely dissolved, and finally obtain a light-yellow translucent viscous liquid.

### Embodiment 4

The adhesive preparation method and the proportion of each ingredient of this embodiment are basically the same with those of Embodiment 3, with the only difference being polyacrylate as the water-soluble polymer of the embodiment with a molecular weight of 150,000; and the final product is a light-yellow translucent viscous liquid.

### Embodiment 5

Add 554 ml water in a 1000 ml beaker, put the beaker on a magnetic stirrer, and heat up to 50° C.; then add 23.2 g gelatin, stir to make it completely dissolved, and titrate with 0.1 M LiOH to adjust pH value of the solution to 9; add 2.9 g PEO composed of PEO with a molecular weight of 250,000 and that with a molecular weight of 150,000 (at a weight ratio of 1:3) after the solution cools down to the room temperature, continue to stir to make the PEO completely dissolved, and finally obtain a light-yellow translucent viscous liquid.

### Embodiment 6

The adhesive preparation method and the proportion of each ingredient of this embodiment are basically the same with those of Embodiment 5, with the only difference being the mixture of PVA and PEO as the water-soluble polymer of the embodiment with a molecular weight of 250,000 and 150,000, respectively (at a weight ratio 1:1); and the final product is a light-yellow translucent viscous liquid.

### Embodiment 7

Add 560 ml water in a 1000 ml beaker, put the beaker on a magnetic stirrer, and heat up to 50° C.; then add 11.6 g gelatin, stir to make it completely dissolved, and titrate with 0.1 M LiOH to adjust pH value of the solution to 8.5; add 8.7 g of the mixture of sodium polyacrylate with a molecular weight of 150,000 and polyacrylate with a molecular weight of 50,000 (at a weight ratio of 1:3) after the solution cools down to the room temperature, continue to stir to make the mixture completely dissolved, and finally obtain a light-yellow translucent viscous liquid.

### Embodiment 8

The adhesive preparation method and the proportion of each ingredient of this embodiment are basically the same with those of Embodiment 7, with the only difference being the mixture of PVA and sodium polyacrylate as the water-soluble polymer of the embodiment with a molecular weight of 150,000 and 50,000, respectively (at a weight ratio 1:1); and the final product is a light-yellow translucent viscous liquid.

### Embodiment 9

Add 582 ml water in a 1000 ml beaker, put the beaker on a magnetic stirrer, and heat up to 50° C.; then add 6 g gelatin, stir to make it completely dissolved, and titrate with 0.1 M LiOH to adjust pH value of the solution to 8; add 12 g PEO with a molecular weight of 250,000 after the solution cools down to the room temperature, continue to stir to make the PEO completely dissolved, and finally obtain a light-yellow translucent viscous liquid.

### Embodiment 10

Add 569.4 ml water in a 1000 ml beaker, put the beaker on a magnetic stirrer, and heat up to 50° C.; then add 30 g gelatin, stir to make it completely dissolved, and titrate with 0.1 M KOH to adjust pH value of the solution to 8; add 0.6 g polyacrylamide with a molecular weight of 450,000 after the solution cools down to the room temperature, continue to stir to make the polyacrylamide completely dissolved, and finally obtain a light-yellow viscous liquid.

### Embodiment 11

Add 588 ml water in a 1000 ml beaker, put the beaker on a magnetic stirrer, and heat up to 50° C.; then add 9 g gelatin, stir to make it completely dissolved, and titrate with 0.1 M NaOH to adjust pH value of the solution to 8; add 3 g PEO with a molecular weight of 250,000 after the solution cools down to the room temperature, continue to stir to make the PEO completely dissolved, and finally obtain a light-yellow viscous liquid.

### Embodiment 12

The manufacturing process is basically the same with that of Embodiment 11, except that the amount of water is 558 ml, gelatin 30 g, and the polymer added is polyvinyl alcohol (PVA) with a molecular weight of 100,000.

### Embodiment 13

Add 680 ml water in a 1000 ml beaker, put the beaker on a magnetic stirrer, and heat up to 50° C.; then add 14 g gelatin, stir to make it completely dissolved, and titrate with 0.1 M NaOH to adjust pH value of the solution to 8; add 9 g PEO (comprising 3 g PEO with a molecular weight of 450,000 and 6 g PEO with a molecular weight of 150,000) after the solution cools down to the room temperature, continue to stir to make the PEO completely dissolved, and finally obtain a light-yellow viscous liquid.

### Embodiment 14

Add 710 ml water in a 1000 ml beaker, put the beaker on a magnetic stirrer, and heat up to 50° C.; then add 20 g gelatin, stir to make it completely dissolved, and titrate with 0.1 M LiOH to adjust pH value of the solution to 8; add 5 g PEO with a molecular weight of 250,000 after the solution cools down to the room temperature, continue to stir to make the PEO completely dissolved, and finally obtain a light-yellow translucent viscous liquid. Add 80% of the prepared adhesive into an eggbeater, and gradually add 1,000 g of the positive electrode powder material of LiCoO₂ (made by CITIC Guoan Information Industry Co., Ltd.) with an average particle size of 7-8 μm while stirring, and stir at a high speed for 30 min after the addition. Then add 20 g of the conductive carbon black, Super P, to the mixture in batch, and stir at a high speed for additional 2 hours. Add the remaining prepared adhesive after the materials have been dispersed uniformly by stirring, and continue to stir for 3 hours. The slurry can be used for the coating process when it is shiny black and has good liquidity.

(1) Manufacture of Positive Plate

Apply the slurry prepared above to a coater of 4 meters in length. The temperatures of the three baking channels in the front, middle and rear of the coater are set at 100° C., 95° C. and 100° C., respectively. The current-collecting aluminum foil is 20 μp in thickness and 280 mm in width. The single-sided coating thickness of the aluminum foil is 130 μm, and the double-sided coating thickness controlled at 250 μm, with the surface density being 425 g/m². The foil, after being dried, turns out to be the positive plate.

(2) Manufacture of Negative Plate

The negative plate is manufactured according to the production process of a negative plate of a liquid-electrolyte lithium ion battery. The graphite from Xingcheng, Changsha is selected as the negative electrode material, and the water adhesives, sodium carboxymethylcellulose (CMC) and SBR latex, are selected as the adhesive. During the slurry preparation process, first dissolve 2 parts by weight of CMC in 100 parts by weight of water, then add 5 parts by weight of SBR latex while stirring, add 92 parts by weight of graphic powder, and finally obtain the negative electrode slurry after continuous intense stir for 4 hours. Then apply the negative electrode slurry to the double sides of a copper foil of 12 μm in thickness with the small coater of 4 m in length, and obtain a negative plate after drying.

(3) Manufacture of Square “053048S” Battery

Cut the positive plate, the negative plate, and a diaphragm paper (Celgard 2300) according to the required size of Model “053048S” battery. Then go through in sequence the following processes commonly adopted in manufacture of the batteries: Spot welding of a tab, drying of the plate, rolling, cladding, laser welding of a cover, drying, and injecting of the electrolyte. The produced battery can then go through a precharging process and a formation process.

(4) Battery Test

Inject 2.4 g of the organic electrolyte into the dried semifinished battery, and leave it for 2 hours. Then test according to a certain charge-discharge system, which is as below: In Step 1, charge with a constant current of 0.05 CmA for 60 min; in Step 2, charge with a constant current of 0.1 CmA for 50 min; in Step 3, charge with a constant current of 0.5 CmA till the voltage reaches 4.2 V; in Step 4, charge with a constant voltage of 4.2 V till the current reaches 30 mA, and leave it for 5 min; in Step 5, discharge at a constant current of 0.5 CmA till the voltage reaches 3.0 V, and leave it for 5 min; in Step 6, charge with a constant current of 1 CmA at a constant voltage; in Step 7, discharge at a current of 1 CmA till the voltage reaches 2.75 V; and thereby finish the steps of precharge and formation of the battery. Finally, seal the battery to produce the finished steel-clad battery Model “0530488”.

Then perform a cycle test on the battery that has been precharged and formed according to the following system: In Step 1, charge with a constant current of 1 CmA till the voltage reaches 4.2 V; in Step 2, charge with a constant voltage of 4.2 V till the current reaches 30 mA, and leave it for 5 min; in Step 3, discharge at a constant current of 1 CmA till the voltage reaches 2.75 V; and cycle according to such a system for times as required.

### Comparative Example 1

Use a commercial lithium-ion secondary battery provided with the positive plate, which is made with LiCoO₂ provided by CITIC Guoan Information Industry Co., Ltd. as the positive electrode material, and with polyvinylidene fluoride (PVDF) and N-methylpyrrolidone as the adhesive. Composition of the positive electrode is as below: 1000 g LiCoO₂, 28 g Super P, 30 g PVDF, and 400 g NMP. Manufacture the negative plate and the 053048S steel-clad battery according to Embodiment 14, and test with the same method as above.

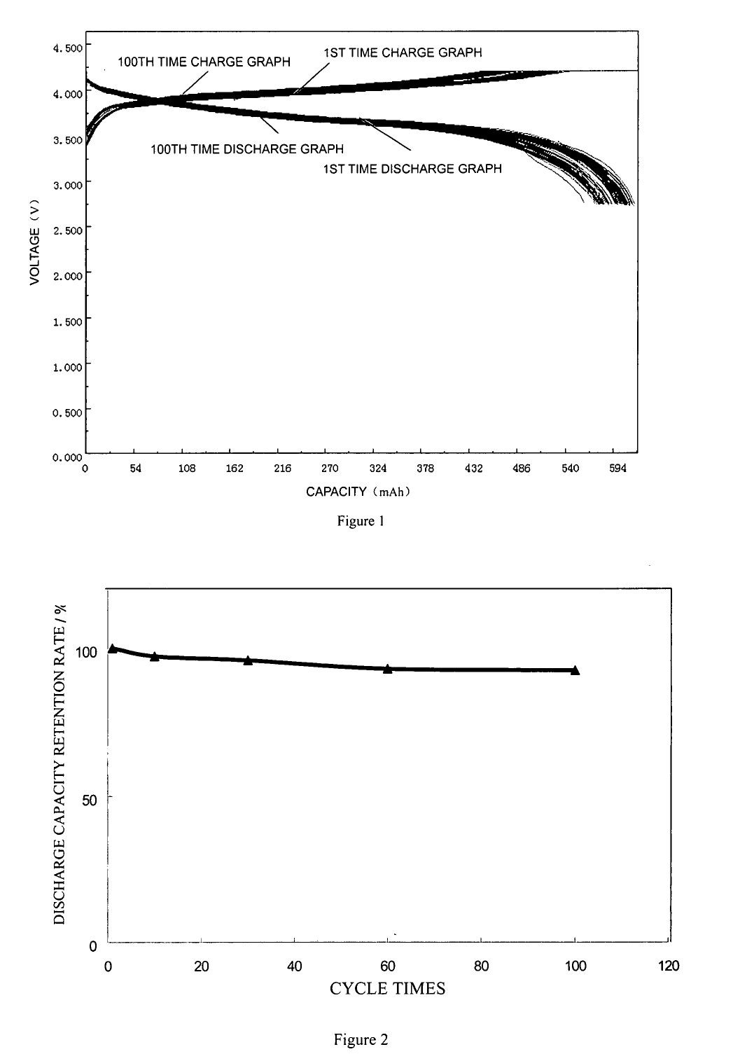

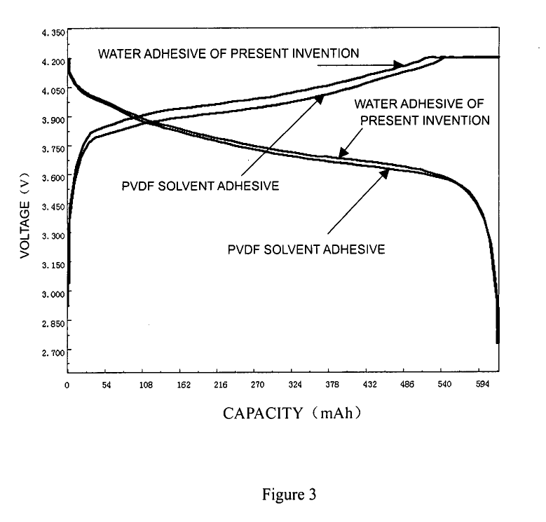

The test result shows that, the battery provided with the positive plate manufactured by the method of the present invention has substantially the same performance as that manufactured with the common oil-phase coating process (refer to FIG. 3). After the 100-time charge-discharge cycle test, the discharge capacity retention rate of the battery provided with the positive plate manufactured by the method of the present invention can reach up to 92%, which satisfies the battery quality standards (refer to FIGS. 1 and 2).

1: A water adhesive, wherein the adhesive is a hybrid solution mainly composed of gelatin, a water-soluble polymer and water.

2: A water adhesive, wherein the adhesive comprises gelatin, a water-soluble polymer and water.

3: The water adhesive according to claim 2, wherein the content of gelatin is 1%-5% by weight, the content of the water-soluble polymer 0.1%-2% by weight, with the remaining being water.

4: The water adhesive according to claim 3, wherein the content of gelatin is 1.5%-4% by weight.

5: The water adhesive according to claim 3, wherein the content of the water-soluble polymer is 0.5%-1.5% by weight.

6: The water adhesive according to claim 4, wherein the content of the water-soluble polymer is 0.5%-1.5% by weight.

7: The water adhesive according to claim 3, wherein the water-soluble polymer can be one of the following high molecular compounds or their mixtures: polyvinyl alcohol, polyethylene oxide, polyacrylamide, sodium polyacrylate, polyacrylate, and polyvinylpyrrolidone.

8: The water adhesive according to claim 7, wherein the water-soluble polymer can be one of the following high molecular compounds or their mixtures: polyvinyl alcohol, polyethylene oxide, sodium polyacrylate, and polyacrylate.

9: The water adhesive according to claim 8, wherein the molecular weights of the water-soluble polymers are as below: polyvinyl alcohol 50,000-450,000, polyethylene oxide 50,000-450,000, sodium polyacrylate 50,000-250,000, and polyacrylate 50,000-150,000.

10: The water adhesive according to claim 8, wherein the molecular weight of the water-soluble polymer is 200,000-300,000.

11: The water adhesive according to claim 8, wherein the water-soluble polymer is polyethylene oxide, with a content of 1.3% by weight, and the content of gelatin is 2% by weight.

12: A preparation method of the water adhesive, wherein the method includes the following steps:
(a) dissolve the scaled gelatin in water;
(b) titrate the above solution with an alkaline solution to make its pH value being 7-9;
(c) then add the scaled water-soluble polymer to the solution; and
(d) stir the solution to completely dissolve the ingredients.

13: The preparation method of the water adhesive according to claim 12, wherein gelatin can be dissolved in water in Step (a) through the following method: add gelatin in water, heat up to 50° C.-80° C., and stir to make gelatin completely dissolved; and in Step (c), add the water-soluble polymer after the solution cools down to the room temperature.

14: The preparation method of the water adhesive according to claim 13, wherein the alkaline solution is LiOH solution.

15: Application of the water adhesive according to claim 13 in manufacture of a positive plate of a lithium ion battery, wherein the application includes a coating step, in which a current-collecting body is coated with the water adhesive and then dried to produce the positive plate.

16-17. (canceled)

18: The water adhesive according to claim 2, wherein the water-soluble polymer can be one of the following high molecular compounds or their mixtures: polyvinyl alcohol, polyethylene oxide, polyacrylamide, sodium polyacrylate, polyacrylate, and polyvinylpyrrolidone.

19: The water adhesive according to claim 18, wherein the water-soluble polymer can be one of the following high molecular compounds or their mixtures: polyvinyl alcohol, polyethylene oxide, sodium polyacrylate, and polyacrylate.

20: The water adhesive according to claim 19, wherein the molecular weights of the water-soluble polymers are as below: polyvinyl alcohol 50,000-450,000, polyethylene oxide 50,000-450,000, sodium polyacrylate 50,000-250,000, and polyacrylate 50,000-150,000.
